(19) United States
(12) Patent Application Publication
(10) Pub. No.: US 2008/0029372 A1
(43) Pub. Date: Feb. 7, 2008

(54) Microfluidic switching devices having reduced control inputs

(76) Inventor: Timothy Beerling, San Francisco, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/497,443

(22) Filed: Aug. 1, 2006

(51) Int. Cl. H01H 29/00

(52) U.S. Cl. 200/182

(57) ABSTRACT

Advantage is taken of the fact that each switching state change (i.e., each throw) of a double throw switch requires a pair of controlled input signals to be applied to the switching element that controls that throw. By sharing input leads among several switches and by arranging the leads with respect to each switch throw element such that for any pair of leads only one switch throw element will activate, it is possible to reduce the total number of leads for the combined switch package. In one embodiment, all of the switches in a switching device are packaged as a single device.

### CROSS-REFERENCE TO RELATED APPLICATIONS

The present application is related to commonly assigned U.S. patent application Ser. No. 10/996,823, filed on Nov. 24, 2004, published as 2006/0108209, May 25, 2006, entitled “LIQUID METAL SWITCH EMPLOYING ELECTROWETTING FOR ACTUATION AND ARCHITECTURES FOR IMPLEMENTING SAME”, which application is hereby incorporated by reference herein.

### BACKGROUND OF THE INVENTION

Microfluidic architectures, are increasingly being used for control purposes. Electrowetting on dielectric (EWOD) technology can be used to construct microfluidic switches as shown in commonly assigned U.S. patent application Ser. No. 10/996,823, filed on Nov. 24, 2004, published as 2006/0108209, May 25, 2006, entitled “LIQUID METAL SWITCH EMPLOYING ELECTROWETTING FOR ACTUATION AND ARCHITECTURES FOR IMPLEMENTING SAME”, which application is hereby incorporated by reference. For example, switching devices are being designed on wafer chips (substrates) where liquid metal within the switch structure opens and closes the switched circuit. Often many such switches are constructed on a single substrate. For example, in the above-referenced application there is shown a single-pole double-throw (SPDT) switch having four control inputs (two for each “throw” position) to control the switched state. In some cases, one of the input controls can be common resulting in three control leads per switch. When multiple switches are constructed on a single substrate the total number of input control leads would be four (or perhaps three) times the number of switches.

Such a large numbers of control inputs is impractical on a single substrate (especially considering the small size of microfluidic devices) and the problem is compounded when the switching circuit is to be used with RF signals since the large number of switching inputs increases the risk of interference with the RF signals.

### BRIEF SUMMARY OF THE INVENTION

Advantage is taken of the fact that each switching state change (i.e., each throw) of a double throw switch requires a pair of controlled input signals to be applied to the switching element that controls that throw. By sharing input leads among several switches and by arranging the leads with respect to each switch throw element such that for any pair of leads only one switch throw element will activate, it is possible to reduce the total number of leads for the combined switch package.

### BRIEF DESCRIPTION OF THE DRAWINGS

FIGS. 1A, 1B and 1C show, in schematic diagram form, an embodiment of a single-pole double-throw switch;

FIG. 2 is a representation of the switch shown in FIGS. 1A through 1C;

FIG. 3A illustrates one embodiment of a switching strategy for three switches of the type discussed above with respect to FIG. 2;

FIG. 3B shows a chart of one possible set of paired control lines for operating three separate switches;

FIG. 4A illustrates one embodiment of a switching strategy for five switches of the type discussed with respect to FIG. 2; and

FIG. 4B shows a chart of which pair of control leads must be made active to cause a particular device to switch.

### DETAILED DESCRIPTION

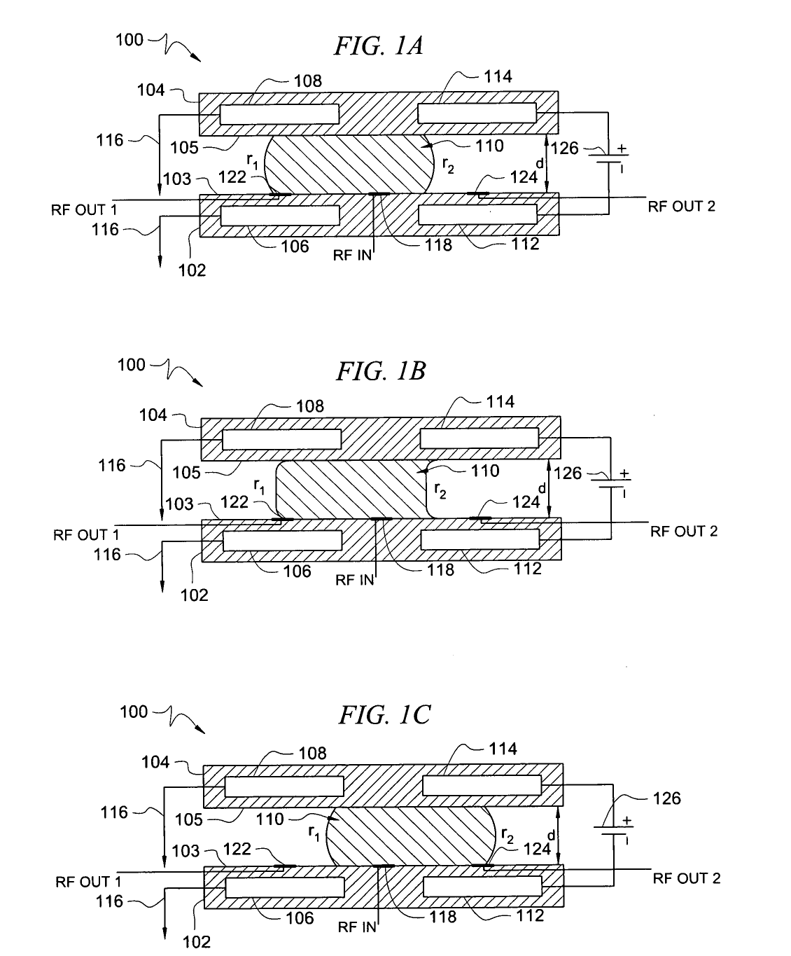

FIGS. 1A, 1B and 1C show, in schematic diagram form, an embodiment of a single-pole double-throw switch, such as switch 100. In FIG. 1A, electrically conductive liquid droplet 110 is shown bridging electrical continuity between RFin contact 118 and RFout1 contact 122 while in FIG. 1C droplet 110 has moved from the left throw position to the right throw position and now bridges electrical continuity between RFin contact 118 and RFout2 contact 124. For a more complete understanding of the operation of switch 100 reference is made to the above-identified application entitled “LIQUID METAL SWITCH EMPLOYING ELECTROWETTING FOR ACTUATION AND ARCHITECTURES FOR IMPLEMENTING SAME”.

As shown in FIG. 1A, switch 100 comprises dielectric 102 having surface 103 forming the floor of the switch, and dielectric 104 having surface 105 that forms the roof of the switch. Droplet 110 of a conductive liquid, such as, for example, mercury (Hg) or a gallium alloy is sandwiched between dielectric 102 and dielectric 104.

Dielectric 102 includes electrode 106 and electrode 112. Dielectric 104 comprises electrode 108 and electrode 114. Electrodes 106 and 112 are buried within dielectric 102 and electrodes 108 and 114 are buried within dielectric 104. In this example, and to induce droplet 110 to move right toward electrodes 112 and 114, electrodes 106 and 108 are coupled to an electrical return path 116 and are electrically isolated from electrodes 112 and 114, and electrodes 112 and 114 are coupled to voltage source 126. Alternatively, to induce droplet 110 to move left toward electrodes 106 and 108, electrodes 112 and 114 can be coupled to an isolated electrical return path and electrodes 106 and 108 can be coupled to a voltage source.

In this example, switch 100 includes electrical contacts 118, 122, and 124 positioned on surface 103 of dielectric 102. In this example, contact 118 can be referred to as an input, and contacts 122 and 124 can be referred to as outputs. As shown in FIG. 1A, droplet 110 is in electrical contact with input contact 118 and output contact 122. Further, in this example, droplet 110 will always be in contact with input contact 118.

As shown in FIG. 1A as a cross section, droplet 110 includes a first radius, r₁, and a second radius, r₂. When electrically unbiased, i.e., when there is zero voltage supplied by voltage source 126, the magnitude curvature of the radius r₁ equals the magnitude curvature of the radius r₂ and the droplet is at rest.

Upon application of an electrical potential via voltage source 126, a new contact angle between droplet 110 and surfaces 103 and 105 is defined thus altering the profile of droplet 110 so that r₁ is not equal to r₂. If r₁ is not equal to r₂, then the pressure, P, on droplet 110 changes and movement is imparted to the droplet causing the droplet to translate across surfaces 103 and 105.

FIG. 1C is a schematic diagram 130 illustrating switch 100 of FIG. 1A after the application of a voltage. As shown in FIG. 1C, droplet 110 has moved and now electrically connects input contact 118 and output contact 124. In this manner, electrowetting can be used to induce translational movement in a conductive liquid and can be used to switch electronic signals.

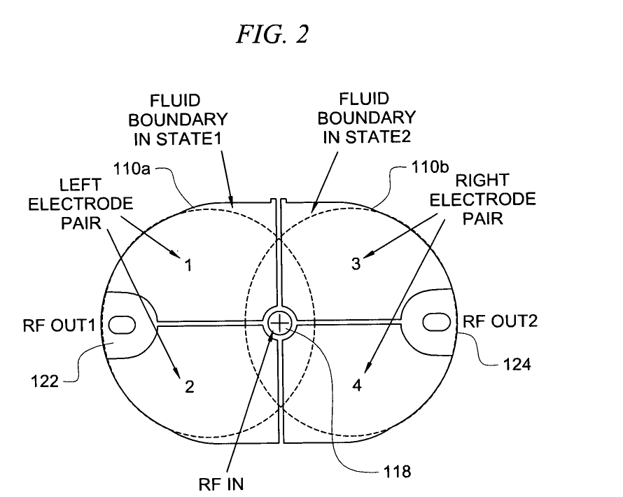

FIG. 2 is a representation of the switch shown in FIGS. 1A, through 1C, except that the electrodes are now only in the floor, and not in the roof. Conductive droplet 110a represents the switch thrown to the left position (between RFin and RFout1 and droplet 110b represents the switch thrown to the right position (between RFin and RFout2). Note that each throw requires a pair of input lines numbered 1 and 2 for the left throw and 3 and 4 for the right throw. These lines are the lines that apply control signals, such as plus and minus voltages (or other signals) to electrodes 108, 106, 114, and 112, respectively, s shown in FIGS. 1A-1C.

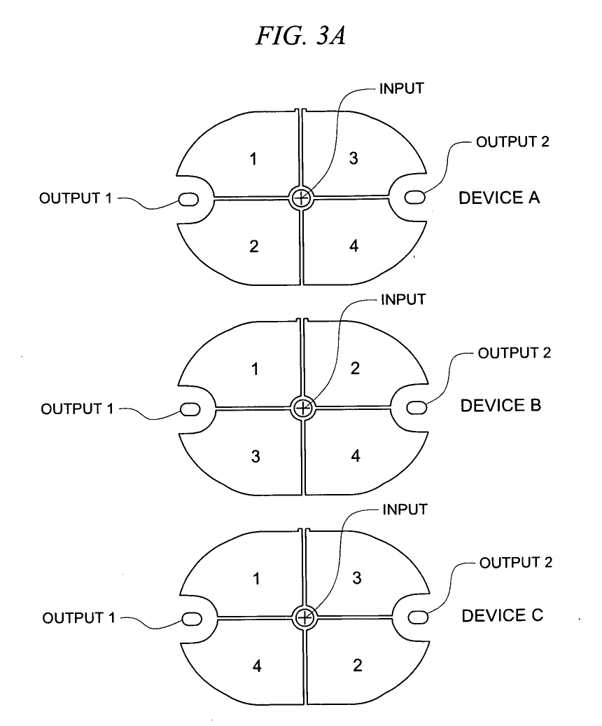

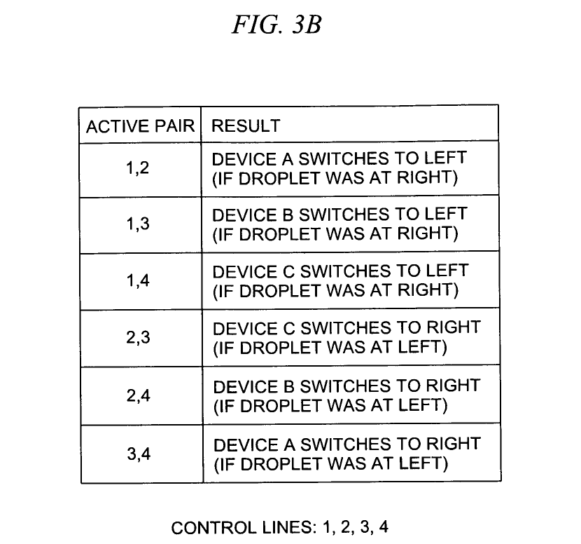

FIG. 3A illustrates one embodiment of a switching strategy for three switches of the type discussed above with respect to FIG. 2. In an embodiment, these can be stacked one on top of the other or they can be constructed on a single substrate side by side, or interleaved or constructed in any other manner desired. The key factor being that the input lines that control the various throw positions are interconnected so that signals on any pair of input leads will operate only one switch throw. Thus, all line 1s are electrically common; all line 2s are electrically common; all line 3s are electrically common and all line 4s are electrically common such that an electrical signal on line 1, for example, would be delivered to line 1 of all devices A, B and C. In some situations, sets of control line pairs can control multiple switches that operate in parallel if so desired.

In operation, all control lines leading to the electrode pairs are driven by off-chip drivers, and these drivers should be tri-state devices, with the drivers in the high impedance state when the liquid metal is not being toggled, as this will minimize RF leakage through the control line. Also, each control line should have a high sheet resistance on the die, also to minimize RF leakage. However, it should be ensured that the RC time constant of the control line should be much shorter in duration than the overall switching time, such that the RC time constant is not a significant contributor to the switching time.

To toggle a SPDT device from state A to state B, the electrode pair that is mostly not covered by the liquid metal is activated, with the other pair left floating (tied to high impedance with, for example, a tri-state driver). The active pair (for device A in FIG. 3A that would be input lines 1 and 2) can be put at some voltage +V and −V: if the voltages are of equal magnitude and opposite polarity, and the electrode areas are approximately the same, this will keep the DC potential of the liquid metal near zero during switching. Provided the liquid is close enough to the active electrode pair to sense the electric field, the liquid will move over the electrode pair, so as to maximize the capacitance in the system. The device has then “switched.” To move the liquid metal to its initial state, one need only change applied bias to the other electrode pair (for device A in FIG. 3A that would be input lines 3 and 4).

With the appropriate microfluidic architecture, and choice of applied bias, only the application of bias +V and −V on either the left pair or right pair will lead to actuation. That is, no matter the state if the fluid, if the applied bias is across one of the electrodes on the right (say input line 3), and one of the electrodes on the left (say input line 1 or input line 2), actuation (switching) will not occur. The liquid metal slug may deform somewhat in response to the applied voltages, but the existing input to output connection will not be broken, and a new connection will not occur.

FIG. 3B shows a chart of one possible set of paired control lines for operating three separate switches shown in FIG. 3A as device A, device B and device C.

Four control lines can control three individual EWOD devices (devices A, B, and C shown in FIG. 3A). There are six unique combinations of the control lines, and each device has two combinations.

As an example, if the droplet were to be at the right in device A (FIG. 3A) the input would be electrically connected to output 2. Then, if input pair 1,2 were to be made active, device A would switch. However, on device B, since lines 1 and 2 are on different throws, the metallic droplet will not move from its existing position whether it be on the right or on the left. The same goes for device C where inputs 1 and 2 are connected to different throws.

Assume now that device C has its input connected to output 1 (droplet to the left) and it is desired to switch device C. Then input leads 2 and 3 would be activated. Only device C would switch because in devices A and B activation of the 2, 3 inputs applies bias to opposite throw positions.

The mathematical formula relating the number of individually controllable switches N, to the number of control lines n, is just the possible pair combinations of n control liens, divided by two (two pairs are required for each device). That is:

$$N = \frac{{}_{}^{n}{C}{}_{2}^{}}{2} = \frac{n !}{2 ( n - 2 ) ! 2 !} \qquad Equation 1$$

where N is the number of controllable devices, and n is the number of control lines. A chart of this expression in terms of the devices shown in FIG. 3A is shown in FIG. 3B. As can be seen, the reduction of control lines is appreciable, particularly for large number of devices on the same die.

One possible drawback: the sharing of control lines between devices may lead to RF coupling between devices, and may be particularly problematic at high frequencies, even with a high sheet resistance used for the control lines. If ultimate RF performance is required, control lines may not be sharable. This is not an issue for low frequency devices.

Another possible drawback: if the number of control lines is reduced using the expression above, the devices can only be switched sequentially; groups of switches cannot be switched simultaneously. This will slow the reconfiguration of switching networks. It may be that some intermediate reduction of control lines is employed, providing some degree of simultaneous switching of multiple devices. In some applications, devices will always switch together—the tip and ring in a telephone copper pair, for example. In this case independence is not required. The choice of the level of reduction of control lines will be application specific.

It should be noted that other physical electrode configurations are possible, but that still can be seen as electrode pairs, with a left pair and a right pair, with each electrode in a pair have about the same area.

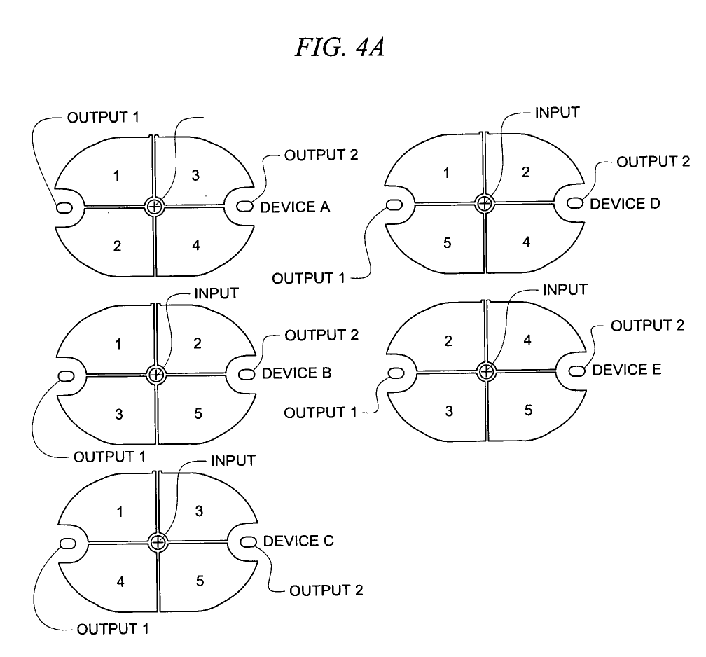

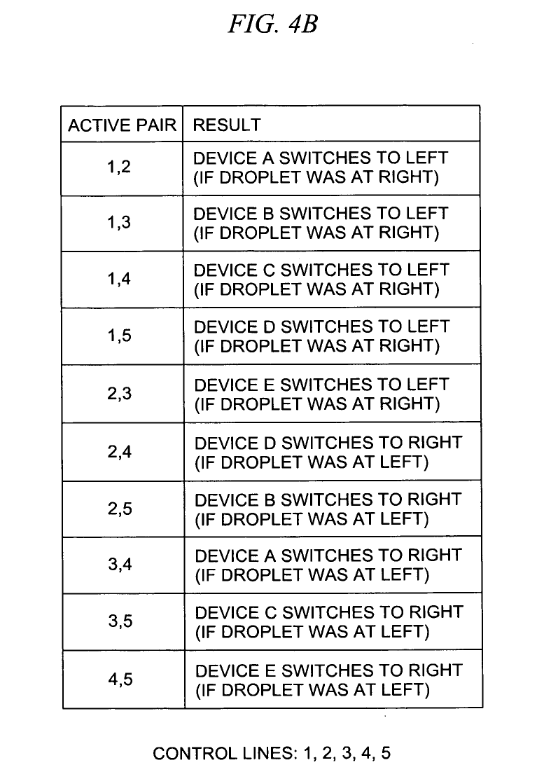

FIG. 4A illustrates one embodiment of a switching strategy for five switches (device A through device E) of the type discussed with respect to FIG. 2.

FIG. 4B is a chart showing which pair of control leads of the devices shown in FIG. 4A must be made active to cause a particular device to switch. Thus, in the example shown, in order to move the droplet of device E from right to left, (switch the input of device E to output 1 from output 2) control lines 2 and 3 must be active and all other control lines must be inactive. To move the droplet of device E from left to right, control lines 4 and 5 must become active and all other control lines must be inactive.

Note that while not shown in FIG. 3A or 4A, the similarly numbered control lines from each device are electrically common and only one physical lead need extend from the combined device package for each numbered control line. Thus, in FIG. 3A only four control lines need exit the package while in FIG. 4A five lines will extend from the package. Note also that each device has an input and two outputs. The connections to these inputs and outputs (not shown) are separately brought out of the package so that external connection can be made thereto. Thus, for example, in the embodiment of FIG. 4A, five input RF leads and ten output RF leads would extend from the package.

This sort of control strategy can work with other switching architectures (e.g., SP3T, SP4T, etc.), provided the correct microfluidic architecture is chosen, along with the appropriate bias voltages and the appropriate formulas relating the number of switches to the minimum number of control lines.

The electrode pairs are situated side-by-side in the floor of the microfluidic channel, but this disclosure is also relevant to electrode pairs configured top and bottom (in the roof and floor of the microfluidic channel, as seen in other electrowetting devices. This disclosure is also relevant to electrowetting structures where the liquid is in direct electrical contact with one of the electrodes in a pair, with the other electrode buried under a dielectric. Other electrode configurations are possible, as are other multi-throw switches.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A switch device comprising:
a plurality N of independent switches, each switch requiring the application of at least two control signals to change its switch state, and
a plurality N of control inputs for delivering said control signals to selected switches, where the relationship between the number N independent switches and the number of control lines is expressed as:
$$N = \frac{{}_{}^{n}{C}{}_{2}^{}}{2} = \frac{n !}{2 ( n - 2 ) ! 2 !}$$

2. The switch of claim 1 wherein each said independent switch further comprising:
at least one RF input terminal; and
at least two RF switched output terminals arranged in a single-pole double-throw relationship with each other and with said RF input terminals, the switch throw controlled by said switch state.

3. A switch device comprising:
a plurality of independent single-pole double-throw switches, each throw of each switch requiring the application of at least two concurrently applied input signals to change its switch state, and
a pair of control lines for each switch state, each control line of said pair operable for delivering to a particular switch one of the two input signals required to change switch states, said control lines for all of said switches of said device electrically connected together in a pattern such that multiple switches share the same control lines but for any given pair of control lines only one switch throw will receive a proper control input and wherein only a subset of all control lines extend external to said switch.

4. The switch of claim 3 constructed on a single substrate.

5. The switch of claim 3 wherein said single-pole double-throw switches are constructed using electowetting on dielectric technology.

6. The switch of claim 4 wherein the number of switches is three and the number of control lines that extend from the switch is four.

7. The switch of claim 6 wherein said three switches are called ONE, TWO, and THREE and said control lines are numbered 1, 2, 3, and 4, and wherein said throw positions are called Left and Right, and wherein said control lines are connected to respective throws of said three switches as follows:

| SWITCH | THROW POSITION | CONTROL LINES |
|---|---|---|
| ONE | Left | 1, 2 |
| ONE | Right | 3, 4 |
| TWO | Left | 1, 3 |
| TWO | Right | 2, 4 |
| THREE | Left | 1, 4 |
| THREE | Right | 2, 3 |

8. A substrate comprising:
N controllable devices constructed on said substrate, each said controllable device requiring at least four control inputs to perform a switching operation; and
n number of control inputs operable to control the states of all N of said controllable devices, wherein
$$N = \frac{{}_{}^{n}{C}{}_{2}^{}}{2} = \frac{n !}{2 ( n - 2 ) ! 2 !}$$

9. The substrate of claim 8 wherein said devices are switches wherein liquid metal is used to toggle between switching operations.

10. The substrate of claim 9 wherein said switches control RF signals.

11. The substrate of claim 10 wherein said control lines are driven by off-substrate tri-state drivers, said drivers arranged in an high impedance state when said liquid metal is not being toggled.

12. A substrate comprising:
a plurality of single pole double throw switches each switch having its individual on/off throws controlled by the movement of liquid metal within the confines of said switch and wherein the direction of movement of said liquid metal for each said switch throw is controlled by two control inputs;
a first on-signal input to said substrate, said on-signal input connected in common to one of said control inputs of a plurality of other ones of said switches; and
N other on-signal inputs to said substrate, individual ones of said on-signal inputs connected to a plurality of said switches such that when on-signals are applied to any two of said on-signal inputs only one of said switch throws activates.

13. The substrate of claim 12 wherein said switches contain a liquid metal droplet which toggles between switch throws in response to a proper on-signal.

14. The substrate of claim 13 wherein said switch throws control RF signals from an input to an output, each said switch on said substrate controlling an individual RF circuit.

15. The substrate of claim 14 wherein said on-signal lines are driven by off-substrate tri-state drivers, said drivers arranged in an high impedance state when said droplet is not being toggled.

16. The method of constructing a plurality of double-throw switches, each switch requiring activation of a pair of control leads for each throw of each switch to effectuate a toggle from one throw to another of said switch; the method comprising:
for each switch, connecting in common one of the four possible control leads with one of the four possible control leads of each other switch, such that when any pair of control leads are activated only one switch throw is toggled.

17. The method of claim 16 further comprising:
extending one toggle control lead from each common connection to an exterior of a package containing said plurality of switches.

18. The method of claim 17 further comprising:
connecting each of said toggle control leads to a tri-state driver.

19. The method of claim 17 further comprising:
connecting an RF input to a center terminal of each said switch; and
connecting RF outputs to each said throw of each said switch.

20. The method of claim 16 wherein at least two of said switch throws are toggled when any one pair of control leads are activated.
